(19) United States
(12) Patent Application Publication
(10) Pub. No.: US 2001/0024409 A1
(43) Pub. Date: Sep. 27, 2001

(54) OPTICAL SCANNING DEVICE

(76) Inventor: JOHANNES L. BAKX, EINDHOVEN (NL)

Correspondence Address: CORPORATE PATENT COUNSEL, U S PHILIPS CORPORATION, 580 WHITE PLAINS ROAD, TARRYTOWN, NY, 10591

(21) Appl. No.: 08/386,794

(22) Filed: Feb. 10, 1995

(30) Foreign Application Priority Data
Feb. 22, 1994 (EP) 94200438.3

(51) Int. Cl. G11B 7/095

(52) U.S. Cl. 369/44.41

(57) ABSTRACT

A scanning device for scanning a record carrier is disclosed which comprises parallel, optically detectable tracks. The device comprises an optical system for focusing via the record carrier a main radiation beam, a first and a second auxiliary radiation beam on a radiation-sensitive main detector, a first auxiliary detector and a second auxiliary detector, respectively. The main detector and auxiliary detectors comprise each at least a first and a second sub-detector. A tracking control system controls a position of a read spot caused by the main radiation beam on the record carrier. In a first operating state first generating means for generating a first tracking error signal are used for generating a differential push-pull signal (Srepp) representative of a combination of mutual differences between detector signals from sub-detectors of individual detectors as an error tracking signal (SRE). In a second operating state second generating means for generating tracking error signals are used for deriving as the tracking error signal (SRE) a signal (Sreca) which is representative of a difference between sums of the detector signals of the sub-detectors of the first and second auxiliary detector.

### BACKGROUND OF THE INVENTION

The invention relates to a scanning device for scanning a record carrier which comprises parallel, optically detectable tracks, the device comprising an optical system for focusing, via the record carrier, a main radiation beam, a first and a second auxiliary radiation beam on a radiation-sensitive main detector, a first and a second auxiliary detector respectively, while the main detector and auxiliary detectors comprise each at least a first and a second sub-detector, the device comprising a tracking control system for controlling, in response to a tracking error signal, a position of a read spot caused by the main radiation beam on the record carrier, which tracking control system can be brought to a first or a second operating state in which tracking control system in the first operating state first generating means for generating tracking error signals are active for generating as a tracking error signal a differential push-pull signal which represents a combination of mutual differences between detector signals from sub-detectors of individual detectors, and which tracking control system comprises second generating means for generating tracking error signals which second generating means are active in the second-operating state and differ from the first generating means for generating tracking error signals.

Such a device is known from EP-A-0.525.896. Prior-art device is, in essence, intended for reading out record carriers which have a track pitch that is approximately half the track pitch customary for so-called Compact Discs. To make the reading of Compact Discs possible too, the device comprises additional provisions. When the record carrier having half the track pitch is read out, the tracking control is brought to the first operating state. In this first operating state a tracking according to the so-called three-spot-push-pull principle is realised. The auxiliary radiation beams are then focused in such a way that in the case where the main radiation beam hits the centre of a track, the auxiliary read spots caused by the auxiliary radiation beam are positioned on either side of the track followed by the main read spot and shifted by distances corresponding to half the track pitch. For each of the three read spots (main read spot and auxiliary read spots), a push-pull signal is derived from the difference between the detector signals of the associated detectors. The push-pull signals thus obtained are combined to the three-spot-push-pull signal which is thereafter used as a tracking error signal in the tracking control system, so that the position of the main read spot is kept centralized on the track.

When the Compact Disc is read out, the tracking control system is brought to the second operating state. In this operating state the control system keeps the centre of the main radiation beam focused on the edge of one of the tracks.

Prior-art device cannot be used for applications in which the main read spot is to be kept centralized on one of the tracks for both types of record carriers such as, for example, applications as described in EP-A-0.482.964.

### SUMMARY OF THE INVENTION

It is an object of the invention to provide a device in which the main read spot can be kept centralized on one of the tracks when either type of record carrier is scanned.

According to the invention this object is achieved by a device as defined in the opening paragraph, characterized in that the second generating means for generating tracking error signals comprise deriving means for deriving as the tracking error signal a signal that represents a difference between the sums of the detector signals of the sub-detectors of the first and of the second auxiliary detector.

The device according to the invention is advantageous in that a tracking error signal can be derived for either type of record carrier on the basis of detector signals, without adaptations for focusing the radiation beams being necessary in the optical system. For that matter, if a record carrier having a specific track pitch is scanned and the distance between the auxiliary read spots and the track followed by the main read spot is equal to half the track pitch, the distance between the auxiliary read spots and the track followed by the main read spot will, in essence, be equal to a quarter of the track pitch if a record carrier having a track pitch that is twice this track pitch is scanned. For distances between the main read spot and the auxiliary read spots, which distances are equal to half the track pitch, it appears that a tracking error signal obtained according to the three-spot-push-pull principle is little sensitive to variations of parameters which may, for example, be caused by eccentricity. For distances between the main read spot in the auxiliary read spots, which distances are equal to a quarter of the track pitch, a tracking signal obtained on the basis of the difference between the radiation received by the auxiliary detectors also appears to be little sensitive to said variations of parameters. With the device according to the invention it is thus possible to realise in a highly simple manner a reliable tracking for the scanning of both a first type of record carrier and a second type of record carrier, whereas the track pitches on the two different types of record carriers have a ratio of 1:2. With said 1:2 ratio of the track pitches, the insensitivity to variations of parameters is optimized. However, there should be observed that also for track pitch ratios lying within the limits of 1.5 and 2.5, a sufficiently high insensitivity to variations of parameters is obtained.

### BRIEF DESCRIPTION OF THE DRAWINGS

The invention will be further explained with reference to the drawing FIGS. 1 to 5, in which:

FIG. 1 shows an embodiment for the scanning device according to the invention;

FIG. 2 shows a top view of a detector system to be used in the device shown in FIG. 1,

FIGS. 3 and 4 show top views of two different types of record carriers which may be scanned by the device according to the invention; and

FIG. 5 shows an adaptation of the embodiment shown in FIG. 1.

### DESCRIPTION OF THE PREFERRED EMBODIMENTS

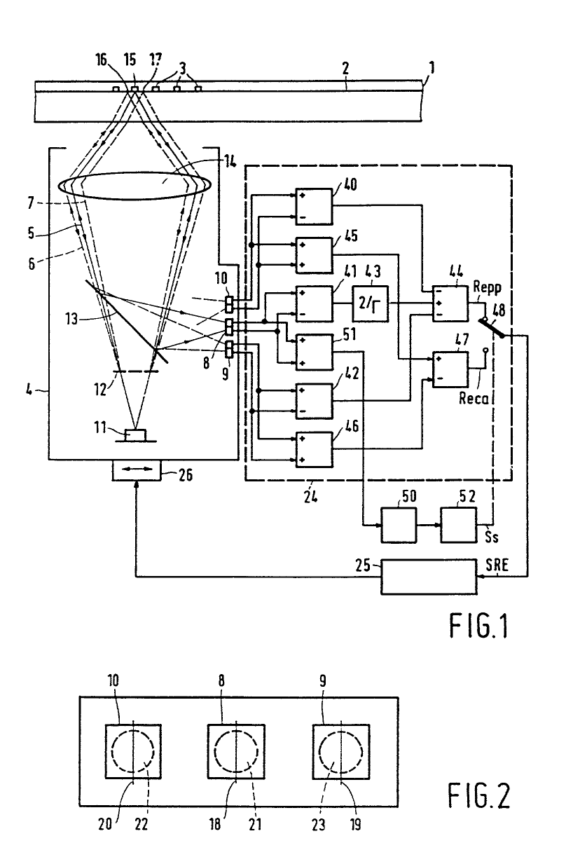

FIG. 1 shows an embodiment for a scanning device according to the invention for scanning an optical record carrier 1, part of which is represented in a cross-sectional view. The record carrier comprises an information plane 2 in which information has stored in the form of a phase structure. This phase structure may be formed by, for example, pits or land on the information plane. The phase structure is ordened in parallel tracks 3 having a constant track pitch. In FIG. 1 the tracks are perpendicular to the plane of the drawing. The device comprises a read head 4. The read head 4 comprises a radiation source 11, for example, a diode laser, for generating a radiation beam. Furthermore, the read head 4 comprises a beam splitter, for example, in the form of a grid splitting up the radiation beam produced by the radiation source 11 into a main radiation beam 5 and two auxiliary radiation beams 6 and 7. The read head 4 comprises an optical system for focusing, via the information plane 2 of record carrier 1, the radiation beams 5, 6 and 7 at a respective radiation-sensitive main detector 8, a first auxiliary detector 9 and a second auxiliary detector 10. The optical system thereto comprises a beam splitter 13 of a customary type, for example, in the form of a semitransparent mirror for separating the beams focused at the information plane and the beams returning from the information plane. Furthermore, the optical system comprises a focusing element 14 of a customary type for focusing the radiation beams 5, 6 and 7 to small read spots 15, 16 and 17 on the information plane 2. The read spot 15 caused by the main radiation beam 5 will be designated the main read spot hereinafter. The read spots caused by the auxiliary radiation beam 6 and 7 will be designated auxiliary read spots 16 and 17 hereinafter.

Each of the main detector 8 and auxiliary detectors 9 and 10 is divided into at least a first and a second sub-detector. In FIG. 2, which shows a top view of the detectors 8, 9 and 10, the division of the detectors 8, 9 and 10 is indicated by the lines 18, 19 and 20. Furthermore, spots caused by the radiation beams 5, 6 and 7 are referenced 21, 22 and 23 in FIG. 2. The optical system and detectors 8, 9 and 10 are dimensioned such that in the case where the main radiation beam 5 is focused on the centre line of the tracks 3 and the auxiliary radiation beams 6 and 7 are focused on the centre line between two parallel tracks 3, the spots 21, 22 and 23 are positioned centralized on the detectors 8, 9 and 10. If the read head 4 is moved in a direction perpendicular to the tracks, the spots on the detectors 8, 9 and 10 will move in a direction perpendicular to the lines 18. 19 and 20.

The device comprises a generating circuit 24 for generating tracking error signals, which circuit derives a tracking error signal SRE from detector signals S8a, S8b, S9a, S9b, S10a and S10b which are supplied by the sub-detectors of the detectors 8, 9 and 10. The tracking error signal SRE denotes the deviation between the centre; line of the main read spot 15 and the centre of the track on which the main radiation beam 5 is focused. The main read spot is kept on the centre line of one of the tracks 3 by a tracking control system. In addition to the generator circuit 24 for generating the tracking error signals, the tracking control system comprises a control circuit 25 and an actuator 26. The actuator is of a customary type for effecting a shift of the read spots 15, 16 and 17 in a direction perpendicular to the tracks 3. The actuator 26 may be formed, for example, by a shift actuator for shifting the read head 4. However, other types of actuators are also suitable. The actuator 26 is controlled by the control circuit 25 which derives a control signal for the actuator 26 from the tracking error signal SRE, so that the tracking error signal is kept at a predetermined value that corresponds to a tracking error that is substantially equal to zero. The tracking control system can be brought to a first or second operating state. In the various operating states various tracking error signals are derived from the detector signals 8a, 8b, 9a, 9b, 10a and 10 b. A first one of the two different operating states is intended to be used in the case where the track pitch of the tracks 3 (distances between the centres of adjacent tracks) is selected to be so large as to have the auxiliary read spots 16 and 17 positioned, in essence, in the middle between two tracks. Worded differently, the auxiliary read spots are shifted relative to the main read spot 15 in a direction perpendicular to the tracks over a distance equal to (n+0.5) times the track pitch. For the purpose of illustration, FIG. 3 shows a top view of the pattern of tracks represented for the case where the auxiliary read spots 16 and 17 are shifted in a direction perpendicular to the tracks over a distance equal to half the track pitch. The tracks 3 are formed by pits which are further designated by reference numeral 60. In the device according to the invention a so-called differential push-pull tracking error signal Srepp is used as a tracking error signal in the case where the auxiliary read spots 16 and 17 are shifted over a distance (n+0.5) times the track pitch. This signal may be derived according to the following relation:

Srepp=(S8a−S8b_l )−r/2 (S9a−S9b)−r/2 (S10a−S10b).

For a further explanation of the relation between the Srepp signal and the detector signals, reference be made to EP-A-0.201.603.

The signal Srepp can be derived by numerous different embodiments of circuits, for example, by a program controlled circuit which is loaded with a suitable program for deriving the signal Srepp according to said relation.

The signal Srepp may also be derived by a so-called hard wired circuit, a possible embodiment of which being formed by the generating circuit 24 for generating tracking error signals shown in FIG. 1. This embodiment comprises a subtracter circuit 40 for determining the difference between the detector signals S10a and S10b, a subtracter circuit 41 for determining the difference between the detector signals S8a and S8b and a subtracter circuit 42 for determining the difference between the detector signals S9a and S9b. An output signal If the subtracter circuit, which signal represents the difference found, is applied to a non-inverting input of an arithmetic circuit 44 via an amplifier circuit 43 having a gain factor 2/P. Output signals of the subtracter circuits 40 and 42 representing the differences determined by these circuits 40 and 42 are applied to inverting inputs of the arithmetic circuit 44. The arithmetic circuit 44 derives the differential push-pull tracking error signal Srepp from the received signals.

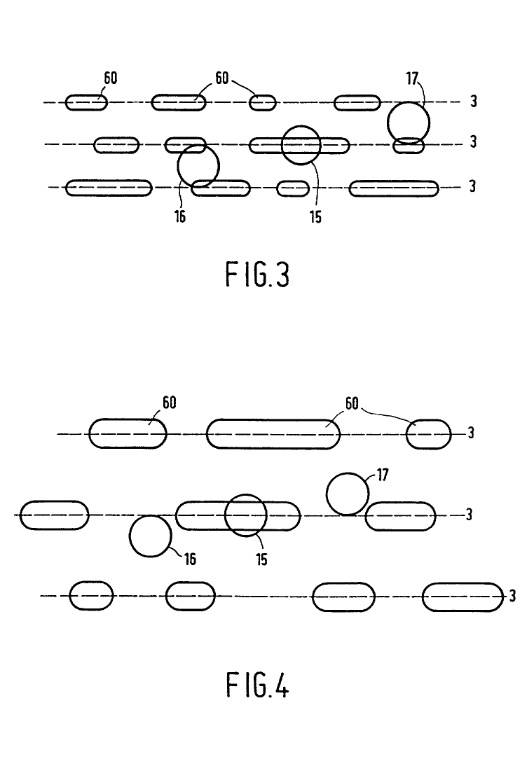

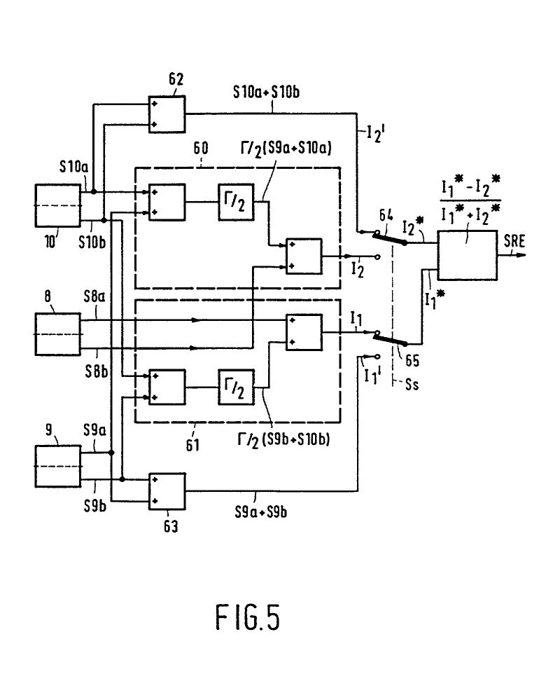

In the device according to the invention, a different tracking error signal is used for tracking if the track pitch is twice the track pitch shown in FIG. 3. FIG. 4 shows by way of illustration a top view of a record carrier having tracks with a track pitch twice that of the record carrier shown in FIG. 3.

For such a track pitch the auxiliary read spots 16 and 17 in a direction perpendicular to the tracks 3 are shifted relative to the main read spot 15 over a distance equal to a quarter of the track pitch. With such a relation between track pitch and distance between the read spots, a signal Sreca derived from the following relation

Sreca=(S10a+S10b)−(S9a+S9b).

is used as the tracking error signal.

For a further explanation of the relation between the signal Sreca and the detector signals, reference be made to GB-1,434,834.

The signal Sreca can be derived by numerous different embodiments of circuits, for example, by a program-controlled circuit loaded with a suitable program for deriving the signal Srepp according to said relation.

The signal Sreca can also be derived by a so-called hard wired circuit of which a possible embodiment is included in the generating circuit 24 for generating tracking error signals shown in FIG. 1. This embodiment comprises an adder circuit 45 for determining the sum of the detector signals S10a and S10b and an adder circuit 46 for determining the sum of the detector signals S9a and S9b. An output signal of the adder circuit 45 representing the sum determined by the adder circuit 45 and an output signal of the adder circuit 46 representing the sum determined by the adder circuit 46 are applied to a subtracter circuit which derives the signal Sreca from these supplied signals.

By means of a selection unit 48, for example, formed by a switch and controlled by a signal Ss, either the signal Srepp or the signal Sreca can be applied to the control circuit 25 as the tracking error signal SRE. The operation of the selection unit 48 may be carried out manually by the user. However, the operation of the selection 48 is preferred to be carried out automatically. This may be effected on the basis of information obtained from the record carrier present in the scanning device. For this purpose the scanning device may comprise a detection unit which establishes the type of record carrier present in the scanning device and which applies an appropriate control signal Ss for the selection unit to the selection unit 48 in the scanning device.

The signal Ss can be obtained in numerous ways. A detection unit may comprise means which effect a shift of the read head over a defined distance and establish the number of passed tracks on the basis of one or more detector signals. This number found is a measure for the track pitch, so that the control signal Ss can be derived from this measure. Another attractive way is including codes in the information signal recorded on the record carrier, which codes indicate the type of record carrier. By detecting these codes the type of record carrier can be established and an appropriate control signal Ss can be generated. It may then be advantageous during the reading of the information signal to use briefly the signal Srepp and the signal Sreca for the tracking. By using the two signals Srepp and Sreca there is guaranteed that at least during part of the readout a suitable tracking error signal is used and a proper tracking is obtained for at least part of the readout of the information signal.

For reading the information signal, the scanning device may comprise a read circuit 50, an input of which is coupled to an output of an adder circuit 51 for adding together the detector signals 8a and 8b. The read circuit 50 may be one of a customary type described in detail . . . , for example, EP-A-0.482.964 and non-prepublished Belgian Patent Application no. 9301334 (PHN 14.662), which documents are considered incorporated herein by reference. The information signal read out by read circuit 50 may be applied to a control circuit 52 which detects a code representing the type of record carrier and generates a corresponding control signal Ss.

FIG. 5 shows another embodiment for a circuit for deriving the tracking error signal SRE in which a normalization of the tracking error signal takes place. Depending on the control signal Ss, the derived value of the differential push-pull signal Srepp or the signal Sreca is produced for the signal SRE, while the following relations hold between the signals Srepp and Sreca, on the one hand, and the detector signals S8a, S8b, S9a, S9b, S10a and S10b, on the other:

$$Srepp = \frac{{I}_{1} - {I}_{2}}{{I}_{1} + {I}_{2}}$$

with I₁ S8a+R/2 (S10b+S9b)

and I₂=S8b+R/2 (S10a+S9a)

$$Sreca = \frac{{I}_{1}^{′} - {I}_{2}^{′}}{{I}_{1}^{′} + {I}_{2}^{′}}$$

with I′₁=S9a+S9b

and I′₂=S10a+S10b.

The device shown in FIG. 5 comprises an arithmetic circuit 60 which derives in customary fashion I₂ from the signals S8b, S10a and S9a. Similarly, I₁ is derived from the signals S8a, S10b, and S9b by means of an arithmetic circuit 61. An arithmetic circuit 62 derives in customary fashion I′₂ from the signals S10a and S10b, whereas an arithmetic circuit 63 similarly derives I′₁ from the signals S9a and S9b. The signals I₂ and I′₂ are applied to a selection circuit 64 controlled by the signal Ss, which circuit 64 presents on its output either the signal I₂ or the signal I′₂ in response to the signal Ss. The signal on the output of the selection circuit will hereinafter also be referenced I₂″.

The signals I₁ and I′₁ are applied to a selection circuit 65 likewise controlled by the control signal Ss. The selection circuit 65 presents on an output either the signal I₁ or the signal I′₁ in response to the control signal Ss. The signal on the output of the selection circuit will be referenced signal I₁* hereinafter. The signals I₁* and I₂* are applied to a normalization circuit of a customary type which derives the signal SRE from I₁* and I₂* according to the following relation:

$$SRE = \frac{{I}_{{1}^{*}} - {I}_{{2}^{*}}}{{I}_{{1}^{*}} + {I}_{{2}^{*}}}$$

Due to the normalization, the tracking error signal SRE becomes less sensitive to all sorts of parameter variations. For a detailed description thereof reference be made to EP-A-0.512.616.

The advantage of the embodiment shown in FIG. 4 is that the same normalization circuit can be used in the two different operating states. With the scanning device described above it is possible to guarantee a most reliable tracking without adapting the optical system for record carriers having a first and a second track pitch. The track pitch ratio is preferably equal to 1:2. However, also with track pitch ratios of two different types of record carriers within the range between 1.5 and 2.5 achieves stable error tracking with the device according to the invention.

The high reliability of the tracking in the scanning device according to the invention will be further explained hereinafter.

The relation between the signal Srepp and the signal Sreca as a function of the tracking error is given by the following formulas:

Sreca=mca*sin(phi)*sin (2πx/q) (1)

Srepp=mcb*(1-cos(phi))*sin(2πx/q) (2)

with phi=2πx0/q

where mca and mcb denote a modulation depth for the signals concerned,

where x denotes the tracking error (distance between the centre of a track to be followed and the centre of the main read spot),

where x0 denotes the shift of the auxiliary read spots relative to the main 4 read spot in a direction perpendicular to the direction of the track, and

where q denotes the track pitch.

As appears from equation 1, the maximum amplitude of Sreca is obtained with phi=π/2, or for x0=q/4. In addition, the sensitivity of Sreca to variations of phi and this value of x0 is minimized.

As appears from equation 2, the maximum amplitude of Srepp is obtained with phi=π, or x0=q/2. In addition, the sensitivity of Srepp to variations of phi is minimized with these values of phi.

Variations of phi are caused, for example, by variation s of the position of the read head relative to the direction of the track. These position variations occur when record carriers are read out having, in essence, concentric tracks and for which the point of rotation does not lie exactly in the centre of the concentric tracks, which phenomenon is also referenced eccentricity. Variations in the position of the read head relative to the direction of the track do occur in the case where the angle of the direction of the track to the track along which the read head travels in radial direction is a function of the radial position of the read head.

Due to these variations of phi it is merely possible to realise a sufficiently stable tracking control with a limited range of phi. In the device according to the invention, both for the scanning of the record carrier shown in FIG. 3 and for the scanning of the record carrier shown in FIG. 4 the amplitude of the tracking error signal is maximum and the sensitivity of the tracking error signal to variations of phi is minimum, so that always a highly reliable tracking is obtained.

I claim:

1. Scanning device for scanning a record carrier which comprises parallel, optically detectable tracks, the device comprising an optical system for focusing, via the record carrier, a main radiation beam, a first and a second auxiliary radiation beam on a radiation-sensitive main detector, a first and a second auxiliary detector respectively, while the main detector and auxiliary detectors comprise each at least a first and a second sub-detector, the device comprising a tracking control system for controlling, in response to a tracking error signal, a position of a read spot caused by the main radiation beam on the record carrier, which tracking control system can be brought to a first or a second operating state in which tracking control system in the first operating state first generating means for generating tracking error signals are active for generating as a tracking error signal a differential push-pull signal which represents a combination of mutual differences between detector signals from sub-detectors of individual detectors, and which tracking control system comprises second generating means for generating tracking error signals which second generating means are active in the second operating state and differ from the first generating means for generating tracking error signals, characterized in that the second generating means for generating tracking error signals comprise deriving means for deriving as the tracking error signal a signal that represents a difference between the sums of the detector signals of the sub-detectors of the first and of the second auxiliary detector.

2. Device as claimed in claim 1, wherein the device comprises means for causing the tracking control system to adopt the first or second -operating state in response to a selection signal, and control means for deriving the selection signal in response to at least one detector signal supplied by the main detector.

3. Device as claimed in claim 1, characterized in that the control means control a read circuit for recovering an information signal that corresponds to information recorded on the record carrier, which control takes place in response to said detector signal supplied by the main detector, and means for producing a selection signal in response to a detection of predetermined codes in the information signal, which detection signal corresponds to this code.
